(19) United States
(12) Patent Application Publication
(10) Pub. No.: US 2005/0231477 A1
(43) Pub. Date: Oct. 20, 2005

(54) Scanning computer mouse

(76) Inventor: Thomas Norman Reid, Reading (GB)

Correspondence Address: ROBERT W. J. USHER;PATENT AGENT, 1133 BROADWAY, #1515, NEW YORK, NY, 10010, US

(21) Appl. No.: 10/503,419

(22) PCT Filed: Feb. 5, 2003
(86) PCT No.: PCT/GB03/00494

§ 371 Date: Aug. 3, 2004

(30) Foreign Application Priority Data
Feb. 7, 2002 (GB) 0202857.9

(51) Int. Cl. G09G 5/08

(52) U.S. Cl. 345/163

(57) ABSTRACT

A computer pointing device comprises a mouse shell (56) having a camera (88) and mouse buttons (70, 72), at the end of a second pantograph arm (40), attached to a first pantograph arm (18), in turn attached to a base clamp (10). In a first embodiment, the angle of the first pantograph arm (18) with the base clamp (10), the angle of the second pantograph arm (40) with the first pantograph arm (40), the angle of the mouse shell (56) with the second pantograph arm (40), and the lengths of each of the pantograph arms (18, 40) are all used by a logic processor (80) to calculate the position of the mouse shell (56) in Cartesian co-ordinates for communication to a host computer.

The present invention relates to a screen-pointing and to scanning assemblies for use with a computer. The invention particularly relates to methods and apparatus where the screen pointing and the scanning functions are combined in a single unit. The invention further relates to software, suitable for use with such apparatus.

Unlike variants of the conventional mouse where two balls measure movement by rolling in two crossed axes, such as the variant described in UK Patent GB 2336 195 B, where material contamination can affect measurement accuracy, the present invention seeks to provide a mechanism having complete insulation from corruption by surface detritus, thereby to ensure high and enduring precision of tracking.

As in the above-mentioned patent GB 2336 195B, the present invention seeks to dispose of the need for a stand-alone, bulky, desktop scanner for presenting representations of images to a computer. Unlike GB 2336 195B, the present invention seeks to provide improved scan accuracy, capable of scanning at resolutions in excess of 200 lines/mm, making the present invention ideal for quality domestic, business and academic use, e.g. in scanning film, rare books and manuscripts.

According to a first aspect, the present invention consists in a computer pointing apparatus comprising: support means, operative to support the apparatus; a first arm, attached by a first end to said support means, said first end of said first arm being rotatable about said support means; a second arm, attached by a first end to a second end of said first arm, said first end of said second arm being rotatable about said second end of said first arm; first angle measuring means, operative to measure the angle between said first arm and said support means and to provide output indicative thereof; second angle measuring means, operative to measure the angle between said first arm and said second arm and to provide output indicative thereof; mouse means at a second end of said second arm; button means selectably operable on said mouse means to provide output indicative of use of said mouse means; and communication means, operative to convey said output of said first angle measuring means, said output of said second angle measuring means, and said output of said button means for use by a computer.

The invention further provides an apparatus comprising logic processing means, operative to receive and convert the indications provided by the output of the first angle measuring means and the output of the second angle measuring means to a position for the mouse means in an orthogonal axis coordinate system, and further operative to communicate the position to the computer.

The invention further provides that support means can comprise first pulley means on, and static with reference to, a base unit, the first end of the first arm rotating co-axially with the first pulley means; second pulley means on the second end of the first arm, the second pulley means being free to rotate with respect to the second end of the first arm; first drive belt means, on the first pulley means and the second pulley means, operative to rotate the second pulley means with respect to the first arm in sympathy with the angle of the first arm to the base unit; third pulley means, co-axial with and fixed with reference to the second pulley means; fourth pulley means, at the second end of the second arm; and second drive belt means, on the third pulley means and the fourth pulley means, operative to turn the fourth pulley means in sympathy with the angle of the first arm to the base unit, the first angle measuring means being coupled to monitor the angle of the fourth pulley means.

The invention further provides an apparatus which can comprise fifth pulley means, on the second end of the first arm and static with reference to the second end of the first arm; sixth pulley means, on the second end of the second arm and free to rotate with respect to the second end of the second arm; and third drive belt means on the fifth pulley means and the sixth pulley means, operative to rotate the sixth pulley means in sympathy with the angle of the first arm with respect to the second arm, the second angle measuring means being coupled to monitor the angle of the sixth pulley means.

The invention further provides an apparatus which can comprise third angle measuring means, operative to measure the angle between a second end of the second arm and the mouse means, and further operative to provide output, indicative thereof, for use by the computer.

The invention further provides an apparatus wherein the logic processor can be further operative to receive and convert the indication provided by the output of the third angle measuring means.

The invention further provides an apparatus wherein the support means can be operative to support the apparatus with the mouse means proximate to a surface of an object whose image is to be captured; the apparatus further-comprising camera means, operative to move with the mouse means, or with the second end of the second arm, and operative to provide, as output, signals indicative of the image of the object.

The invention further provides an apparatus which can comprise image processing means, operative to receive the output from the camera means and to provide output to communicate the image to the computer and the the output of the image processing means can be coupled as input to the logic processing means for the logic processing means to provide the image to the computer.

The invention further provides an apparatus wherein the logic processor means is further operative to provide operational commands to the image processor means and wherein the operational commands include commands from the computer.

The invention further provides an apparatus wherein the first arm can equal in length to the second arm or the first arm and the second arm can be of equal but varying lengths.

The invention further provides an apparatus wherein the support means can comprise a base clamp, affixable to support the apparatus in a plurality of attitudes. And wherein the base clamp can be fixed to a subsidiary extension arm clamp

The invention further provides an apparatus wherein the camera means can comprise a selectably operable light source to illuminate the object whose image is to be captured and wherein the light source can comprise a light emitting polymer.

The invention further provides an apparatus wherein the first angle measuring means can comprise a first pre recorded hard drive platter and and a reading head for reading angular data therefrom, wherein the first hard drive platter can comprise first, second and third radially aligned pre-recorded tracks, the pre-recorded tracks each comprising a plurality of radially aligned markers, and the apparatus employing Fleming's Right Hand Rule of magnetic induction to determine direction of rotation of the platter, wherein the apparatus can comprise read head logic operative to read the markers from the first, second and third pre recorded tracks and to apply ‘best of three’ error correction, and wherein each of the first, second and third pre recorded tracks can comprise 1,296,000 equispaced angular markers.

The invention further provides an apparatus wherein the second angle measuring means can comprise a second pre recorded hard drive platter and a reading head for reading angular data therefrom, wherein the second hard drive platter can comprise first, second and third radially aligned pre-recorded tracks, the pre-recorded tracks each comprising a plurality of radially aligned markers, the apparatus employing Fleming's Right Hand Rule of magnetic induction to determine direction of rotation of the platter, wherein the apparatus can comprise read head logic operative to read the markers from the first, second and third pre-recorded tracks and to apply ‘best of three’ error correction, and wherein each of the firsts second and third pre recorded tracks can comprise 1,296,000 equispaced angular markers.

The invention further provides an apparatus wherein the third angle measuring means can comprise a third pre-recorded hard drive platter and a reading head for reading angular data therefrom, wherein the third hard drive platter can comprise first, second and third radially aligned pre-recorded tracks, the pre recorded tracks each comprising a plurality of radially aligned markers, the apparatus employing Fleming's Right Hand Rule of magnetic induction to determine direction of rotation of the platter, wherein the apparatus can comprise read head logic operative to read the markers from the first, second and third pre recorded tracks and to apply ‘best of three’ error correction, and herein each of the first, second and third pre recorded tracks can comprise 1,296,000 equispaced angular markers.

The invention further provides an apparatus wherein the first angle measuring means can comprise a first nano-mechanical platter; wherein the first nano mechanical platter can comprise a plurality of imprinted tracks; wherein each imprinted track can comprise a plurality of radially aligned angularly equispaced angular markers; and wherein the apparatus can comprise a reading head for reading the angular markers from the first nano mechanical platter, wherein the first nano mechanical platter can further comprise a ferromagnetic track and a magnetic head for reading from the ferromagnetic track, wherein the apparatus can comprise magnetic read head logic employing Fleming's Right Hand Rule of magnetic induction to determine direction of rotation, and wherein each of the plurality of tracks can be etched with 1,296,000 radially aligned angular markers.

The invention further provides an apparatus wherein the second angle measuring means can comprise a second nano-mechanical platter; wherein the second nano mechanical platter can comprise a plurality of imprinted tracks; wherein each imprinted track can comprise a plurality of radially aligned angularly equispaced angular markers; wherein the apparatus can comprise a reading head for reading the angular markers from the second nano mechanical platter; wherein the second nano mechanical platter can further comprise a ferromagnetic track and a magnetic head for reading from the ferromagnetic track; wherein the apparatus can comprising magnetic read head logic employing Fleming's Right Hand Rule of magnetic induction to determine direction of rotation; and wherein each of the plurality of tracks can be etched with 1,296,000 radially aligned angular markers.

The invention further provides an apparatus wherein the third angle measuring means can comprise a third nano-mechanical platter; wherein the third nano mechanical platter can comprise a plurality of imprinted tracks; wherein each imprinted track can comprise a plurality of radially aligned angularly equispaced angular markers; wherein the apparatus can comprise a reading head for reading the angular markers from the third nano mechanical platter; wherein the third nano mechanical platter further can comprise a ferromagnetic track and a magnetic head for reading from the ferromagnetic track; wherein the apparatus can comprise magnetic read head logic employing Fleming's Right Hand Rule of magnetic induction to determine direction of rotation, and wherein each of the plurality of tracks can be etched with 1,296,000 radially aligned angular markers.

The invention further provides an apparatus which can comprise a base mat; the base mat comprising a first plurality of spaced conductors parallel to a first axis; the base mat comprising a second plurality of conductors parallel to a second axis, perpendicular to the first axis; the apparatus comprising first current generating means operative to supply current to the first plurality of conductors; the apparatus comprising second current generating means operative to supply current to the second plurality of conductors; and the apparatus comprising detector means, associated with the mouse means and operative to detect and to provide output indicative of the detection means being situated at the crossing of one of the first plurality of conductors and one of the second plurality of conductors, the output being coupled for use by the computer.

The invention further provides an apparatus which can comprise a first gear chain for magnifying the angular movement of the first arm with respect to the support means and operative to couple the magnified angular movement to be measured by the first angle measuring means; which can comprise a second gear chain for magnifying the angular movement of the second arm with respect to the first arm and operative to couple the magnified angular movement to be measured by the second angle measuring means; which can comprise a third gear chain for magnifying the angular movement of the second arm with respect to the mouse means and operative to couple the magnified angular movement to be measured by the third angle measuring means, and wherein the magnified angular movement can be magnified by a factor of 36.

The invention further provides an apparatus which can be co-operative with the computer to scan a representation of an image of an object into the computer by noting the position of the camera means at each acquisition of an image slice, by assembling the image slices in the computer, and by indicating to a user those portions of the image to be acquired which have not yet been scanned.

The invention further provides an apparatus which can be co-operative with the computer to define the area from which an image is to be acquired by employing the button means to define corners of the area.

Whereas prior art scanning methods require that a document, photograph or other object be moved to and scanned in a scanner, the present invention seeks to bring the scanner function to the objects to be scanned rather than bringing objects a scanner, thereby adding greatly to the utility of such items as laptop computers.

To avoid damaging surfaces of objects to be scanned, the present invention permits a protective layer such as overhead projector film to be interposed between the scanner and the scanned object. However, a smooth layer of film, in contact with another smooth surface, can generate ‘Newton's Rings’. To avoid this, the present invention provides that photographic film can be scanned emulsion side up. If Newton's Rings develop between the light-box glass and the film, the present invention further provides that stippled (on one side), overlay film can be used, provided that the image is not distorted. The invention further provides that scanning can be by direct contact, with the object to be scanned and the sliding surfaces blown free of grit and other detritus by high pressure air and scanning thereafter taking place with gentle pressure between the object to be scanned and the sliding surfaces. Where Newton's Rings persist the film can be held in a mounting frame when fine focussing is attained by a vernier lens adjustment.

The present invention further provides a useful bridge between digital photography and classical, silver halide techniques by allowing archiving of photography collections with at least the same definition as the originals.

The invention further provides that the communication means can include high speed methods, such as those used in the ‘Firewire’™ (IEEE1394 and successors) protocol.

The present invention is further explained, by way of example, by the following description, to be read in conjunction with the appended drawings, in which;

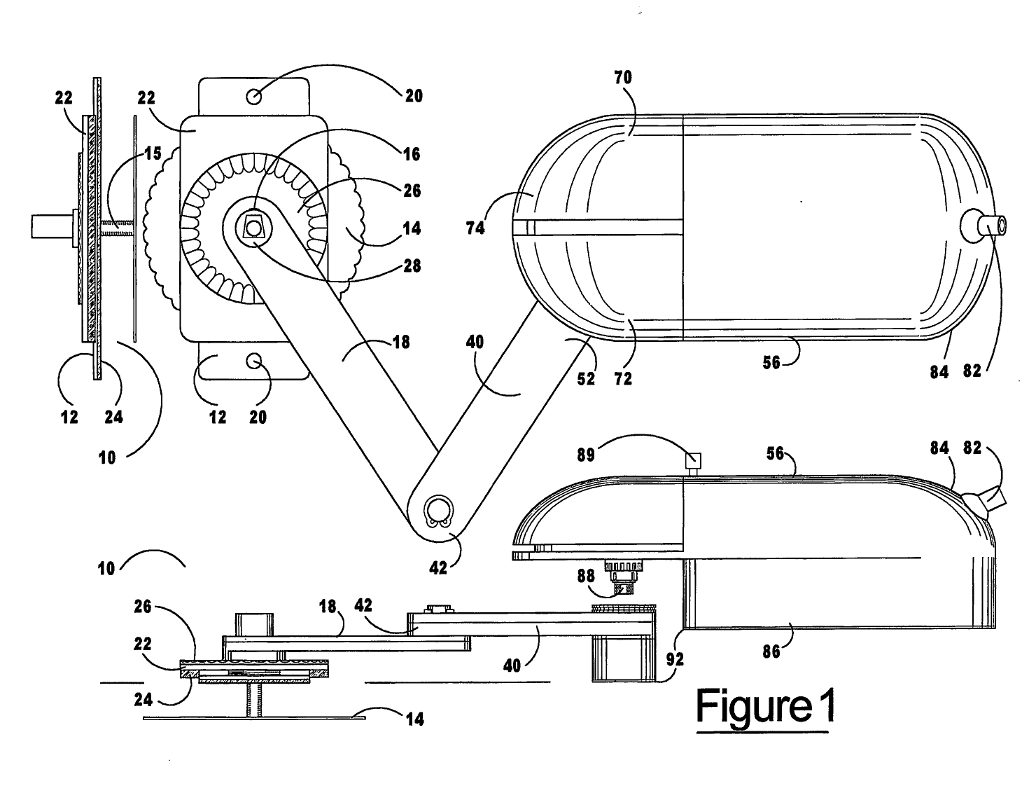

FIG. 1 shows a series of views of a first embodiment of a pointing and scanning apparatus, constructed according to of the present invention.

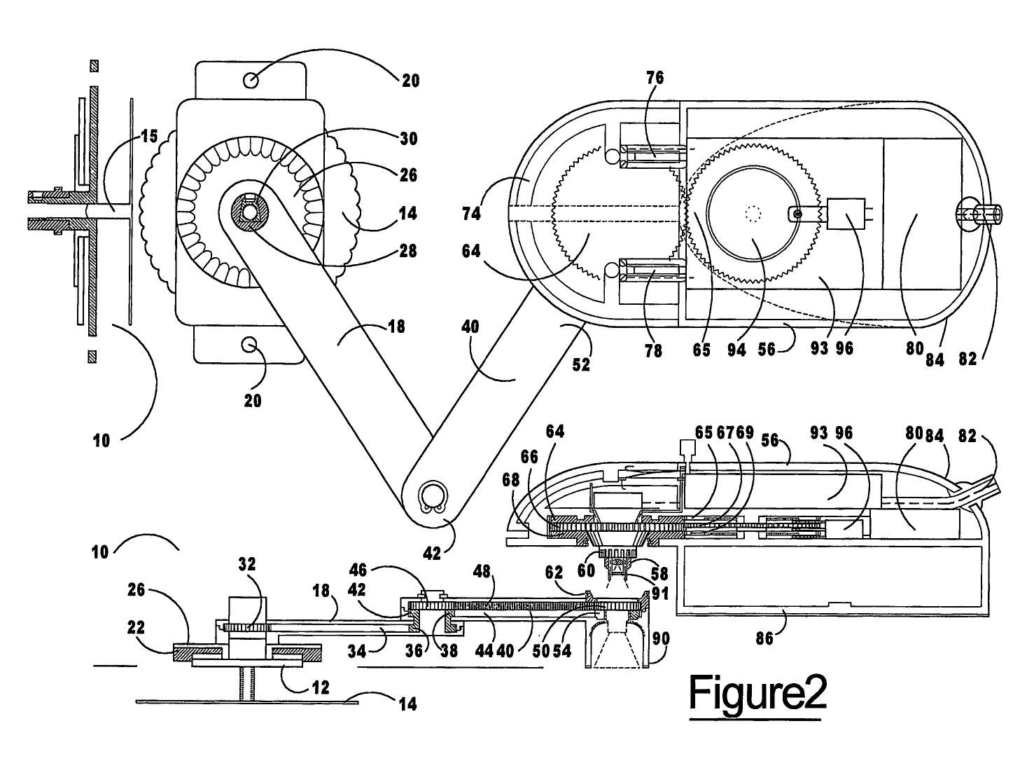

FIG. 2 shows the apparatus of FIG. 1, with cutaway portions to show internal detail, showing a first form of arm angle measurement apparatus.

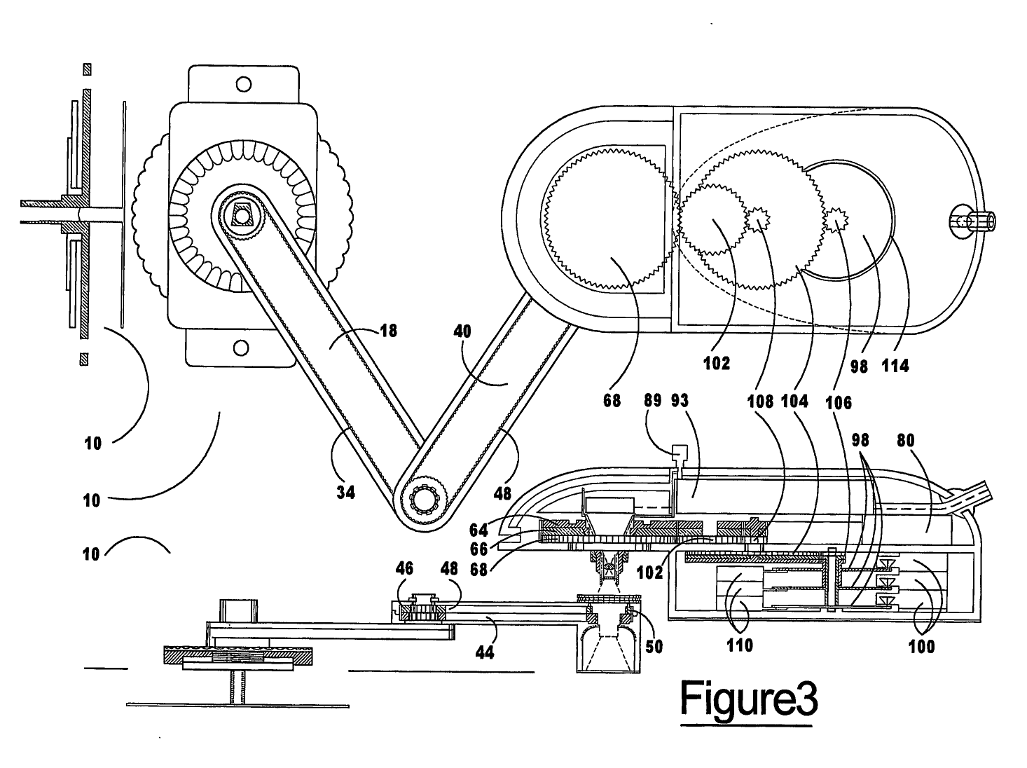

FIG. 3 shows a second embodiment of the invention, having an alternative form of arm angle measuring apparatus to that shown in FIG. 2.

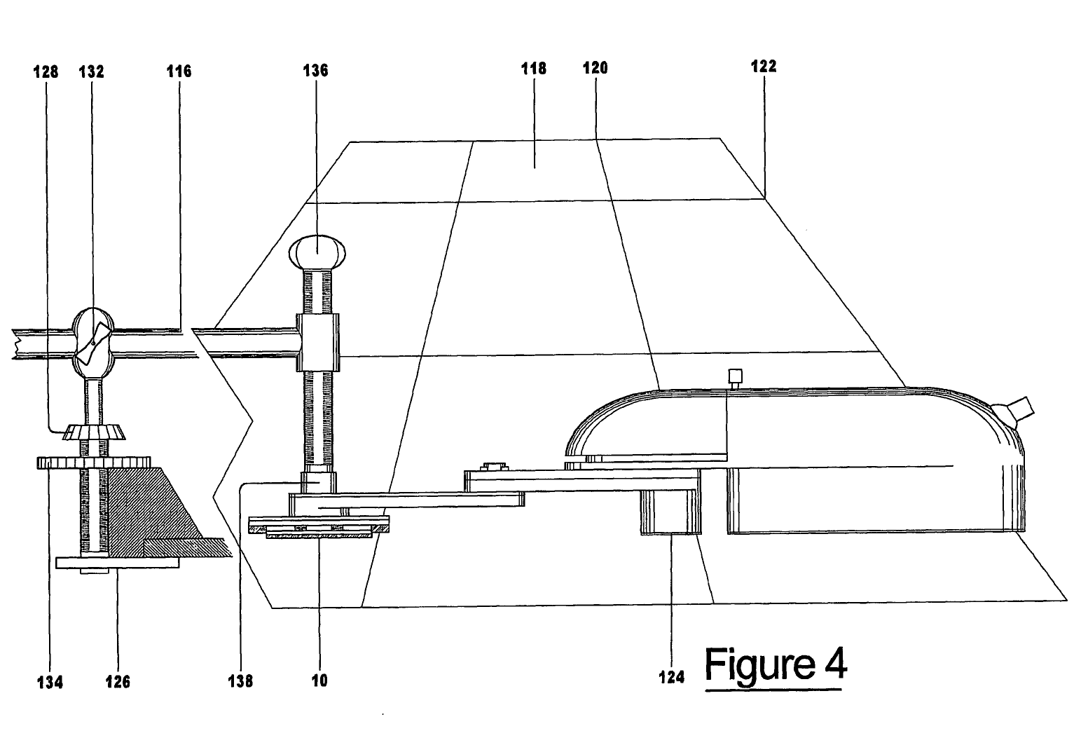

FIG. 4 shows a side elevation of the apparatus of FIGS. 1, 2 or 3, supported on a subsidiary arm to provide a wider scanning range, and also illustrates how partial scanned images are identified and collated to provide a complete scanned image.

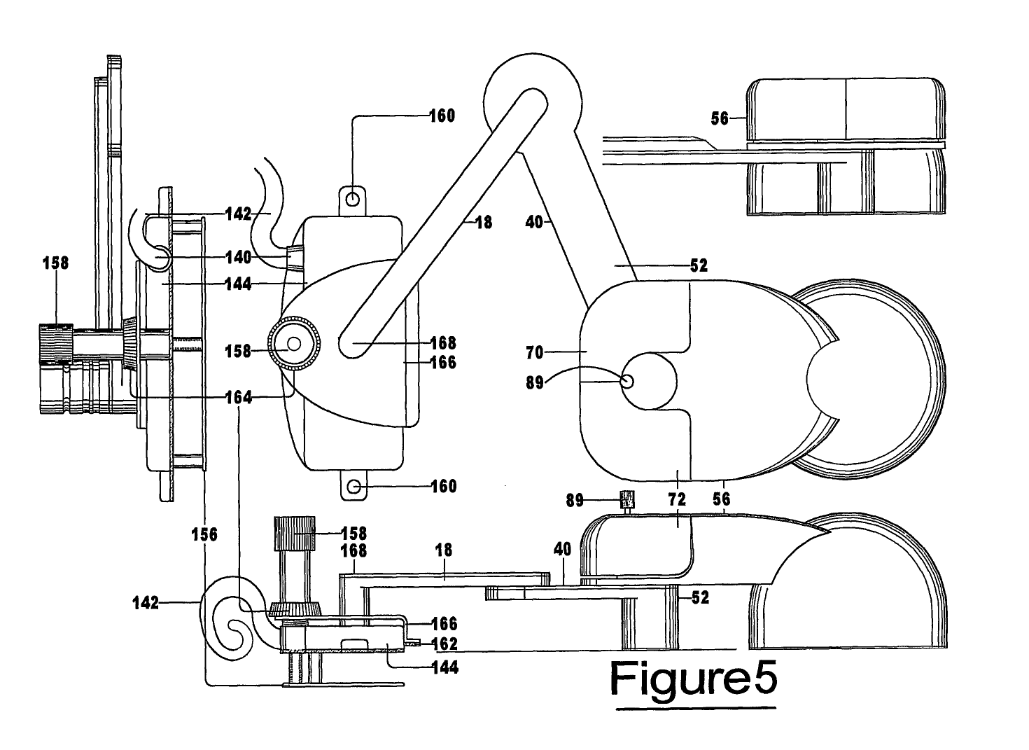

FIG. 5 shows a series of views of a third embodiment of a pointing and scanning apparatus, constructed according to of the present invention.

And

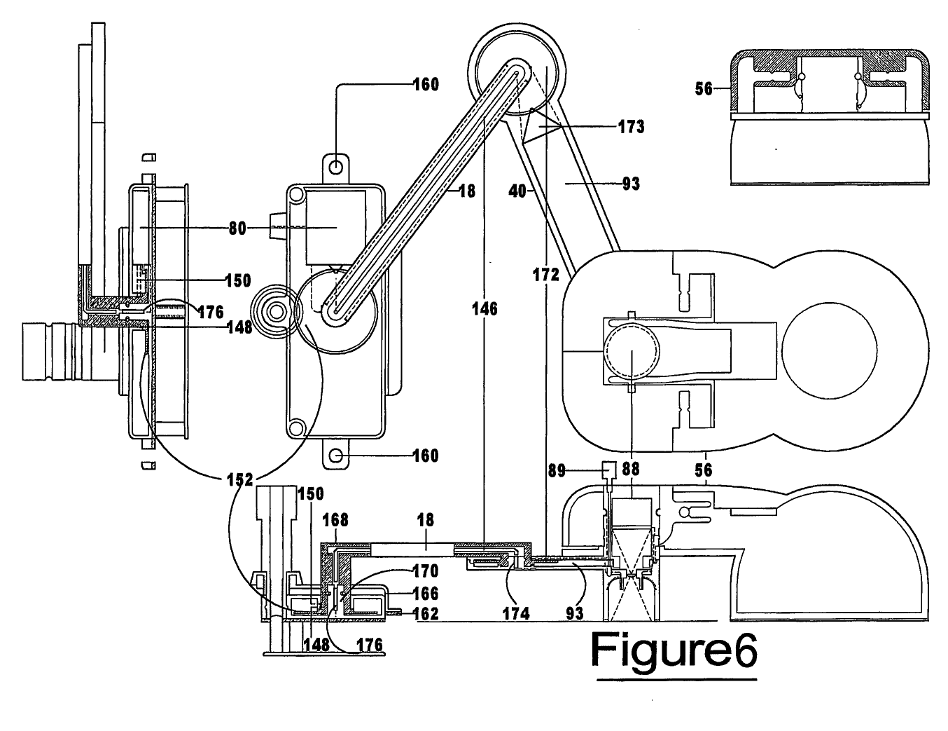

FIG. 6 shows the apparatus of FIG. 5, with cutaway portions to show internal detail and showing a third form of arm angle measurement apparatus.

Attention is first drawn to FIGS. 1 and 2 showing, in FIG. 1, a first series of views of a first embodiment of a pointing and scanning apparatus, constructed according to of the present invention and, in FIG. 2, the apparatus of FIG. 1, with cutaway portions to show internal detail.

A base unit 10 consists of a fixed part 12, under-sealed with a pimply, rubber layer 24 to be gripped to the edge of a baseboard (or a mouse-mat or a wedge of pages in a bound book) by an adjustable part 14, consisting of a knurled disc around a fixed part axle 15 which screws into the fixed part 12 through a pivot 16 for a first pantograph arm 18. A cylindrical void in the pivot is threaded only partly along the length of the fixed part to draw in axle 15 when rotated by the knurled disc. The upper outer walls of the fixed part's pivot void are smooth: to take the locating pin of a subsidiary extension clamp, otherwise shown in FIG. 4.

FIG. 1 shows an embodiment of the invention in where the adjustable part 14 detaches from the fixed part 12 after 10.5 mm of unscrewing. Thus the combination of the fixed part 12 and the adjustable part 14, in this example, makes an effective clamp for up to about 8 mm of baseboard thickness. Other sizes and ranges of unscrewing are possible.

When completely unscrewed, the adjustable part 14 may be set aside and the fixed part 12 may be permanently screwed to a baseboard using screw holes 20. This method is particularly appropriate, using tapped bolts, when attaching the base clamp 10 to the edge of a light-box for film scanning, where the use of double-sided, sticky tape or of mastic would corrupt the surfaces. The adjustable part 14 is also completely unscrewed when using a later described subsidiary extension arm.

Above the fixed part 12 of the base unit 10 is a moveable plate 22 which acts as the document clamping element, the moveable plate 22 is edged by two rubber strips 24 which overlap the fixed part 12 and which are parallel to the spine of the base unit 10. The moveable plate 22 may be advanced or retracted by a screw, operated by a dimpled wheel 26.

The example of an embodiment of the present invention, shown in FIG. 1, provides maximum movement, given to the moveable plate 22 by adjustment of the dimpled wheel 26, of around 1.5 mm, a range of adjustment which is sufficient to grip single sheets of paper, or to grip overhead-projector, acetate film when it is used to protect the surface of photographic film, or of rare manuscripts, from being scratched by any grit caught under a sliding Teflon shoe of a later described mouse shell (and a later described digital camera lenshood). Other ranges of adjustment are possible.

Attention is next also drawn to FIG. 2.

A part axle 28 is slid over and screws onto a support post 30 integral with the fixed part 12 of the base unit 10 and provides a bearing surface for the first pantograph arm 18. The support 30 post has a wedge shaped cross section when viewed in plan with the first pantograph arm 18 and locks the part axle 28 and hence the first pulley 32 within the first pantograph arm 18 and so locks the first pulley 32 within an unambiguous position with respect to the spine of the base unit 10. The outer casing of the end of the first pantograph arm 18 proximate to the first pulley 32 is free to rotate about the smooth sections of support post 30 and is secured on the support post 30 by the flanges of first pulley 32. As the first pantograph arm 18 rotates about the locked, first pulley 32, the first pulley 32 comprising a square-sprocket pulley surface, an inelastic, preferably Teflon, square-toothed, first drive belt 34 converts the rotation into a linear translation.

Returning attention to FIG. 1, the example of an embodiment of the present invention, given in FIG. 1, provides a pantograph set (starting with the first pantograph arm 18) with equal length arms of around 90 mm from pivot centre to pivot centre. As will later become clear, other lengths, and ratios of lengths are possible.

FIG. 2 reveals that first pantograph arm 18 is nearest to the base unit 10 and envelops the first square-sprocket pulley 32 at that end of the first pantograph arm 18 which is proximate to the base clamp, and also envelops a square-sprocket second pulley 36 at that end of the first pantograph arm 18 which is distal from the base unit 10. The first pulley 32 and the second pulley 36 are connected to each other by the inelastic, square-toothed, Teflon, first drive belt 34.

The first pulley 32 is locked in alignment with the spine of the base unit 10 with the first pantograph arm 18 free to rotate there about. The second pulley 36 is rotated by the first drive belt 34 and is moulded with a third upper pulley 38, situated above second pulley 36 and located in a second pantograph arm 40.

The axle of the combined moulding of the second and third pulleys 36 and 38 is hollow and concentric with a shaft anchored to the carcase of the first pantograph arm 18. At the upper end of the shaft anchored to the first pantograph arm 18 the fifth pulley 46 is located. The fifth pulley 46 at the first end 42 of the second pantograph arm, is coupled to move a second drive belt 48 whose position and movement serve to record the angle of the elbow made by the first pantograph arm 18 and by the second pantograph arm 40.

The second pantograph arm 40 comprises the square-sprocket third pulley 38 at the first end 42 of the second pantograph arm 40, and a fifth, square-sprocket pulley 46, also at the first end 42 of the second pantograph arm 40. The second drive belt 44, coupled to the fourth pulley 54, is accompanied by a third, inelastic, square-toothed drive belt 48, coupled to the fifth pulley 46 and immediately above (or, in an alternative embodiment, immediately below) the second drive belt 44, so that the second 44 and third 48 drive belts are situated one below the other.

The second drive belt 44 communicates the angular movement of the first pantograph arm 18 with respect to the spine of the base unit 10, to a fourth pulley 54 pulley proximal to a second end 52 of the second pantograph arm 40. The third drive belt 48 communicates, to a sixth pulley 50, also proximal to the second end 52 of the second pantograph arm 40, the angular movement of the spine of the second pantograph arm 40 with respect to the spine of the first pantograph arm 18.

The second pantograph arm 40 snaps into a mouse shell 56 and is secured by a spring clip. Movement of the second drive belt 44 and of the third drive belt 48 is communicated to the mouse shell 56 by a first concentric shaft 58 and by a second concentric shaft 60. Outside of the second concentric shaft 60 is a third concentric shaft 62, integral with the carcase of the second end 52 of the second pantograph arm 40 and splined to drive a third gear 68, the lowest of a set comprising a first gear 64 coupled to rotate with the first concentric shaft 58, a second gear 66, coupled to rotate with the second concentric shaft 60, and the third gear, coupled to the second end 52 of the second pantograph arm 40. The first 64, second 66 and third 68 gears all have the same diameter. The length of the first pantograph arm 18 and the length of the second pantograph arm 40 are communicated to the host computer with which the mouse device is to be used, and to and on-board logic, when the mouse device is initialized and at set-up.

The second gear 66 in the mouse shell 56 is splined to be driven by the sixth pulley 50 in the second arm. The first gear 64 is splined to be driven by the fourth pulley 54 in the second pantograph arm 40. Thus the three gears 64, 66, 68 in the mouse shell 56 rotate to record angular changes, the third gear 68 recording the angle between the mouse shell 56 and the second pantograph arm 18, the second gear 66 recording the angle between the first pantograph arm 18 and the second pantograph arm 40, and the first gear 64 recording the angle between the first pantograph arm 18 and the spine of the base unit 10.

The external appearance of the mouse shell 56 is the same for the embodiment of the invention shown with respect to FIG. 1 and 2, and for a further embodiment, described hereafter, the contents of the mouse shell 56 recording, in each example, angular movements. First 70 and second 72 mouse buttons are provided in the mouse nose 74, the mouse buttons 70 72 being configurable for left handed and for right handed operation, the handedness of operation being selectable, in particular, dependently upon the base unit 10 being positioned at the top of a document, to the left of a document, or to the right of a document. The second pantograph arm 40 is spring-clipped to, and rotates within, the mouse shell 56.

First 76 and second 78 electrical contacts, respectively for the first 70 and second 72 mouse buttons, are wired to a logic processor 80 which can be provided in various positions in the mouse shell 56.

Wiring 82 leaves from the tail 84 of the mouse shell 56, the tail 84 being at the opposite end of the mouse shell 56 from the mouse buttons 70 72, unlike a conventional computer mouse. The wiring 82 connects to a computer preferably via a Firewire™ socket, or by a USB socket, in the computer. Other means of connection are also possible.

The mouse shell 56 comprises a mouse shoe 86. A digital camera 88 comprises a lenshood 90. The mouse shoe 86 and the annular lenshood base comprise a layer of 0.5 mm of Teflon 92 to provide a sliding contact between the mouse shoe 86 and any object, film or document surface.

The digital camera 88 is provided concentrically with the hole through the first concentric shaft 58. The digital camera 88 views through the hole in the third concentric shaft 58, and thereby through the gears 64 66 68, the digital camera 88 having a field of view which is beneath the mouse shell 56 where the mouse shell 56 joins with the second end 52 of the second pantograph arm 40.

The pantograph effect of the first and second pantograph arms 18 40, in combination with the action of the first, second and third drive belts 34 44 48 ensures that pulley 54 always rotates in parallel with the spine of the base unit 10. The image processor 93 calculates which line of pixels to read from the digital camera's receptor as to ensure a north-south alignment with the indicia and an east-west scanning sweep.

The digital camera 88 is provided with a lens of ‘macro’ design, with a very short distance to the object to be focussed, that distance being almost identical to the distance from lens of the digital camera 88 to the focal plane of the digital camera 88. The lens is designed to give sufficient depth of field to focus a sharp image of both the surface of a document, or to focus through overhead-projector, acetate film to the document or photographic film below the acetate film.

To assure focussing where film is suspended below the acetate surface, a vernier mechanism 89 is provided, adjustable from outside the mouse shell 56, operative either to move the digital camera 88 with respect to an object to be scanned (i.e.; towards or away from the plane of the mouse shoe 86) and/or to move the lens of the camera 88 so properly to focus the object or document to be scanned. As is later explained, this is achieved when the image, captured by the camera 88, is displayed on the display screen of the computer to which the apparatus is connected.

The embodiment given in FIG. 2 has the digital camera 88 capturing a circular image of diameter about ½″ (12.7 mm). The digital camera 88 embodies an image capture semi-conductor device. Where this comprises a CCD (Charge Coupled Device) for capturing the image, then for sufficient resolution, if the camera were to resolve 200 lines/mm, the CCD, being ½″ (12.7 mm) in diameter, then it would need to present a screen of about 10 megapixels, arranged in a hexagonal configuration. This is because each pixel needs to be covered with one of three primary colour filters or left clear thus requiring four adjacent pixels for one point of resolution. An alternative image capture device would be the Foveon X3™ (CMOS) chip which offers further advantages in requiring no primary colour masks and no pixel merging software.

The lens of the digital camera 88 is surrounded by and masked from a cylindrical, light-emitting polymer (LEP) 91 which reflects off the shoulders of the lenshood 90 (integral with the second arm) to illuminate the image area with white light when the invention is switched to scanning mode and the image is not a back-lit film. When selecting 'scanning mode’ as is explained hereafter with reference to driver software, a user is asked to choose whether the light 91 should be ‘on’ or ‘off’. The lens of the digital camera 88 can also be covered by a polarising filter to reduce unwanted reflections of light from the document or film surface.

Output from the digital camera 88 is wired to an image processor 93, which can be provided in various locations in the mouse shell 56, before being transmitted, via the logic processor 80, for preference to the Firewire™ (or USB) socket of a computer.

The three gears 64 66 68, located under the mouse buttons 70 72, drive one of two variants of other gears housed towards the rear of the body of the mouse shell 56. Implementation of either variant will depend on the best or the most adequate available technology. The two examples, given hereafter, comprise just two examples of the various embodiments which can be provided for the present invention.

A first embodiment is shown in FIG. 2. The embodiment shown is simpler than that of FIG. 3 to manufacture. Each of the first 64, second 66 and third 68 gears drives a corresponding one of three following gears 65, 67, 69, each of which carries a platter 94 on one side thereof. Each platter 94, in this embodiment, for preference, comprises an anti-ferromagnetically coupled media (AFC) ™, using a ruthenium layer, incorporated into the platters 94 of IBM™ Microdrive™ hard drives.

Embedding such platters 94 in the three following gears 65 67 69 of the mouse shell 56 makes it possible to measure each of the three angles of the pantograph arms 18 40 to one second of arc. The use of the following gears 65 67 69 make it possible to move the area, in the mouse shell 56, where the angles are measured, so as best to utilize the limited space in the mouse shell 56.

Each platter 94 must be pre-recorded with a triplet of adjacent tracks (at approximately diameter 24mm.) having radially concentric ‘ones’ and ‘zeroes’ with the ‘one’ being radially aligned with each other.

For this, physical formatting must be used, not logical formatting. Error correction on read-out is achieved by taking a ‘best of three’ vote from each track to determine whether a one or zero is recognised.

In the event that the ‘read-out’ is not unanimous then the recalcitrant bit is rewritten as a ‘one’.

To record one second of arc accuracy, 1,296,000 ‘ones’ must be pre-recorded on each of the three tracks (separated by ‘zeroes’). At a track diameter of 24mm, this requires a recording density of approximately 33,000 bits/mm, which can be achieved using AFC™ technology with a particle, domain size of 9 nanometers.

Direction of movement of the disk platters 94, read by triple, Giant Magneto-resistive (GMR™), read-heads 96 is determined by the direction of current flow, according to Fleming's ‘Right-hand Rule’ of magnetic induction.

Attention is next drawn to FIG. 3, showing a second embodiment of the present invention employing ‘CD-ROM’ platters 98 with proprietary read-lasers 100. The embodiment shown in FIG. 3 uses CD-ROM platters 98, of diameter 32 mm.(as developed by Dataplay™), to record the angular movements of the pantograph arms 18 40.

To improve resolution with the CD-ROM platter 98, the initial set of Teflon gears 64,66,68 having 72 teeth drives a gear train (102 to 108 through 104 to 106) magnifying movement 36 times so that each platter 98 rotates once for every 10 degrees of change of the pantograph arm 18 40 angles, i.e. 36,000 seconds of arc.

Three tracks 114 are pre-burned into each of the three CD-ROM platters 98 at diameters of 30.2, 30.4 30.6 mm creating 18,000 pits per track on the master, and creating 18,000 bumps per track on the copies.

The reverse side of each platter has a ferromagnetic track where read heads 110 use Flemings Right Hand Rule to determine direction of rotation. A unit of angle on a CD-ROM platter 98 is defined by a burned ‘pit’ followed by an unburned ‘land’.

18,000 ‘marks’ per 100 represents one ‘mark’ for every 2 seconds of arc. Given arms of length 90 mm., 200 lines/mm. of optical scanning resolution can be achieved.

Attention is next drawn to FIG. 4, showing a third embodiment of the present invention employing a subsidiary extension arm 116. The particular example given in FIG. 4 is illustrated using the first and second embodiments of the invention, otherwise shown in FIGS. 1, 2 and 3. It is to be appreciated that the subsidiary extension arm can equally well be employed together with the third embodiment, otherwise shown in FIGS. 5 and 6.

The use of the extension arm 116 is to allow the invention to retain the use of short pantograph arms which allow highest position resolution. However, this also means that a large surface must be scanned piece by piece and some means must be employed to associate the separately scanned pieces so that they can be assembled into a complete image, as if it were a patchwork quilt.

The device for achieving this is a special, acetate, film overlay 118 which is big enough to cover the whole of area to be scanned. The film 118 which is scored with fine grooves, filled with transparent, iridium oxide conductors. One side of the film 118 has scores 120 in the ‘y’-direction and the other side of the film 118 has scores 122 in the ‘x’-direction.

The conductors 118 112 are connected to a transponder which, whenever it receives an activation signal from a x-conductor 120 and a y-conductor 122 at the same time, will respond by transmitting the grid coordinates of those conductors to the point of activation. Activation is accomplished by the lenshood of the digital camera in the second pantograph arm where a loop aerial 124 is installed. When the aerial 124 picks up the response, it passes it to the logic processor 80 which checks to see that the camera 88 is still within the grid boundary which was selected at set-up time. If the camera is still within the grid boundary selected at set up, the image from the camera is recorded, but if the camera is not within the grid boundary selected at set up, the images from the camera 88 are ignored and a direction warning shown on the computer screen.

The subsidiary extension arm 116 is attached to the edge of the object to be scanned using a subsidiary extension arm clamp 126, which is wound up or down using a first knurled wheel 128 to such a height as to allow the mouse shell 56 to pass underneath (if required, but at least high enough to clear the second pantograph arm 40). A second knurled wheel 134 is used to tighten the extension.

The subsidiary extension arm 116 itself may be lengthened or shortened by pulling and pushing it through a ferrule 132 and then fixing it in position with a butterfly screw in the ferrule 132. Rotation of the subsidiary extension arm 116 is accomplished about a screw adjuster of the subsidiary extension arm clamp 126 base clamp, before a clamping wheel 134 is finally tightened.

During this set up process the invention's lenshood aerial 124 is ‘looking’ for a junction on the overlay 118 grid. When a junction is indicated on the computer screen, final tightening may take place.

The base unit 10 of the first embodiment of the invention, otherwise shown in FIGS. 1, 2 and 3, has its own screw up clamp removed and downward pressure (onto the acetate overlay) is accomplished by turning a butterfly head of a fixing screw 136. The fixing screw 136 has a cylindrical extension which slides into the axle void 138 of the base unit 10, otherwise shown in FIGS. 1 and 2.

Successive sections of the overlay 118 grid are set up and scanned until the user right clicks the second mouse button 72 to select ‘finish’ from a menu.

The process of checking for missed scan sections is done on a grid by grid basis.

Attention is next drawn to FIGS. 5 and 6, showing a fourth embodiment of the invention, FIG. 5 showing a series of views of a fourth embodiment of a pointing and scanning apparatus, constructed according to the present invention, and FIG. 6 showing the apparatus of FIG. 5, with cutaway portions to show internal detail and to show a third form of arm angle measurement apparatus.

The ‘swing-over’ symmetry of the previously described embodiments of FIGS. 1, 2, 3 and 4 is sacrificed, in the examples given in FIGS. 5 and 6, in favour of a radial symmetry centred on the scanning head, but still making a mid-left/top-centre/mid-right location of the base unit possible with respect to material to be scanned.

The embodiment shown in FIGS. 5 and 6 makes it possible to remove all dragging cables from the mouse shell 56 by providing a a stationary exit 140 to the computer for a ‘Firewire’™, USB or other cable 142 from the base unit 144. This is achieved by housing the angle-measuring mechanisms in the base unit 144 and in the second pantograph arm 40, by reducing the number of angles to be measured to two, by eliminating the drive belts 34 44 48, and by integrating the digital camera 88 and image processor 93 and read heads 173 within with the second pantograph arm 40.

FIG. 6 shows alternate views of the items of FIG. 5. In the embodiment, shown in FIGS. 5 and 6, power is, for preference, provided to the digital camera 88 through a first iridium-plated, arm commutator 148 and a second iridium plated arm commutator 150 and using ‘Firewire’™ (or any appropriate) protocols to deliver captured images through a plastic fibre optic bridge 146 to the base unit 144.

As in the first and second embodiments, two variants are offered for measuring the angles subtended by the pantograph arms 18, 40: in this case IBM Microdrive™ hard drive platters 152 and 172; or nano-mechanically engineered platters 152 and 172 with sculpted ridges radially aligned along the rims. With the latter, added ferrite track determines direction of rotation.

In the embodiment shown in FIGS. 5 and 6, only two discs 152 and 172 are required—as there is no need to measure the angle of the second pantograph arm 40 with respect to the mouse shell 56.

The base unit 144 embodies a clamp shell (shown in FIG. 5), undersealed with a pimply, rubber layer to grip parallel to the edge of a baseboard (or a mouse-mat or a wedge of pages in a bound book) and an adjustable part.156, dragged up by a knurled knob 158 driving a threaded rod (behind the pivot for the first pantograph arm 18) which pulls the clamp plate 156 up toward the base unit 144.

As in the embodiments shown in FIGS. 1, 2, 3 and 4, the embodiments shown in FIGS. 5 and 6 allows the adjustable clamp plate 156 to be detached from the base unit 144 after 10.5 mm of unscrewing. Thus it makes an effective clamp for up to about 8 mm of baseboard thickness.

When completely unscrewed, the adjustable clamp plate 156 may be set aside and the base unit 144 may be permanently screwed to a baseboard using screw holes 160. As in the embodiment shown in FIGS. 1 and 2. This is the appropriate method (but using tapped bolts) when attaching the base unit 144 to the edge of a light-box for film scanning. Double-sided, sticky tape or mastic would corrupt the surface.

The centre of the clamp screw 158 is bored out, similarly to the embodiment shown in FIG. 4, to take the insert from the subsidiary extension clamp 126.

A moveable plate 162 is operated by a knurled ring 164 on a shaft coaxial with that of the base clamp plate. The moveable plate 162 can be adjusted by the knurled ring 164 to occupy a range of positions above (when the base unit 144 is horizontal) the indicia level of the base unit 144.

This moveable plate 162 forms part of a document clamp 166 which extends over the base unit 144 beneath the first pantograph arm 18 and lowers the ‘L-shaped’ extension 162 parallel to the spine of the base unit 144. The example shown in FIGS. 5 and 6 shows a maximum movement of 2.0 mm, similar to the examples shown in FIGS. 1 and 2, but at one side of the base unit 144 only. And, so the side views of the base unit 144 are mirror images of the plan views in FIGS. 5 and 6.

The outer casing of the first end 168 of the first pantograph arm 18 is free to rotate (and within it the shaft of a first pulley) about a support post 170 on the base unit 144 and snaps over the round section of the support post 170 to be secured by a springy split-ring.

As the first pantograph arm 18 rotates about the support post 170 of the base unit 144, it engages a first angle measuring disc 152 which records rotation of the first pantograph arm 18 with respect to the base unit 144.

The example, given in FIG. 5 and 6, and as given in FIGS. 1 and 2, provides a set of first pantograph arms 18 and second pantograph arms 40 which have equal length arms, preferably 90 mm from pivot centre to pivot centre. However, in the example given in FIGS. 5 and 6, to give the base unit 144 sufficient depth to house the angle-measuring discs 148, the first pantograph arm 18 is mounted above the second pantograph arm 40 instead of below it, as is the case in the example given in FIGS. 1 and 2.

The first pantograph arm 18 contains no drive belts, but contains a fibre optic bridge 146 from the second pantograph arm 40 to the base unit 144. The first pantograph arm 18 locks into the second pantograph arm 40 and drives a second angle-measuring disc 172 therein.

The second angle measuring disc 172 in the second pantograph arm 40 is driven by the first pantograph arm 18. The second pantograph arm 40 is made integral, at its second end 52, with the digital camera 88 and also houses the image processor 93 and read heads 173 in its length. Thus, the digital camera 88, which is the same as shown and described with reference to FIGS. 1, 2, 3 and 4, swings with the second end 52 of the second pantograph arm 40 and does not rotate with the mouse shell 56, unlike the examples given in FIGS. 1, 2, 3 and 4.

Signal output from the image processor 93 is communicated, for preference, by protocol IEEE 1394a (‘Firewire™’) via a transducer 174 through the fibre optic bridge 146, together with data from the image processor 93 and mouse shell 56, the fibre optic bridge 146 being coupled to a second transducer 176 which drives the logic processor 80. Movements of the second angle measuring disc 172 are also transmitted to the logic processor 80 via the fibre optic bridge. Electrical signals, from the logic processor 80, to the digital camera 88 and to the image processor 93 are coupled, via the fibre optic bridge 146, in the opposite direction.

A subsidiary extension arm 116, as shown in FIG. 4, can also be employed in the examples shown in FIGS. 5 and 6, the subsidiary extension arm 116 being pluggable into the base clamp adjuster in the same manner.

Driver software is provided in two physical locations. Both the examples given in FIG. 1 to 4 and the example given in FIG. 5 and 6 have driver software present in the computer to which the present invention is coupled.

The logic processor 80 also has its own software, used to co-operate with the software, resident in the host computer to handle tracking and screen-pointing functions. The image processor 93 also is provided with software, concerned with scanning functions.

The logic processor 80 comprises a microprocessor with CMOS RAM (Random Access Memory) whose memory is maintained by a small rechargeable battery. The software, held in the microprocessor, counts and keeps track of outputs, indicative of angular movements the elements monitored, by means of the platters 94, of the CD ROM platters, and of the angle measuring discs 152 and 172 as they are variously provided in the various embodiments of the present invention. Knowing the lengths of the pantograph arms 18 40, the logic processor 80, converts the angular changes into Cartesian displacements from the last stationary position of the discs' axis over the surface to be scanned.

When in pointing mode, the displacements are sent to the USB/“Firewire™” socket of the host computer at timed intervals.

When in ‘scanning mode’ the displacements are sent continuously to the host computer with each slice of image from the digital camera 88. An image slice consists of that pixel line which at set up is deemed north/south to the indicia (to send the whole camera image whenever there is a movement would overload an USB channel—but is less likely using the IEEE1394 transmission protocol). The Logic processor 80 interrogates the image processor 93 to extract an image slice whenever one of the angles changes. The logic processor 80 also employs the usual mouse protocol to send ‘click’ codes from the mouse buttons 70 72.

The software in the image processor 93 accesses the image receptors in the camera 88 and reads their charge through analogue-digital converters (ADC), taking red, green, blue-filtered and ‘white’ receptors in turn at each pixel site (except in the case of the Foveon X3™ chip—where the primary colours are read off from three layers and integrated into a single attribute string).

The ADC readings are converted to ‘attribute strings’ of information (32 or 64 bit strings, describing colour and intensity) and stored in a buffer before the logic processor 80 empties it for transmission (with its displacement co-ordinates) through the USB/“Firewire™” channel.

During active scanning, the image processor 93 only reads the line of pixels on the camera screen along a diameter parallel to the indicia north/south line. However, at Registration, when two opposite vertices of a rectangle are selected on the document for image capture, the full camera image is transmitted for each vertex, with cross-hairs superimposed upon it. It is here where the IEEE1394, broadband protocol is an advantage.

The host computer, to which the present invention is coupled, is provided with host driver software. Just as for a conventional mouse, the host-resident driver software is activated at ‘boot-up’ and, thereafter, runs continuously as a multitasked activity.

At ‘boot-up’, the host resident software assumes that the mouse orientation corresponds to a pointer displayed in the middle of the computer screen. The host resident software also assumes that the mouse is aligned north-south and that any movements (regardless of how the mouse actually lies) cause displacements in the x/y directions of this assumption. In the embodiments shown in FIGS. 5 and 6, only the location of the camera axis is crucial.

In the case of this invention, the driver software also has to assume the orientation of the entire assembly, its default is to the base unit being horizontally clamped to the top of a document, with the pantograph arms at forty-five degrees to the base and shell and at ninety degrees to each other.

If the user wishes to change the location of the base, then the mouse shell 56 is moved to place the screen pointer over a small mouse ‘icon’ in the task bar, the right button 70 is clicked and the screen pointer moved to highlight ‘Properties’ from a popped-up menu which is selected by left-72 clicking upon it. Subsequent menu selection allows the base unit 10 to record as centre left, centre right or (default) centre top. It also allows the pantograph arms 18 40 to be configured for the screen centre, position of the pointer. The degree of the movement of the mouse shell 56 can also be specified for screen-pointing (it does not have to have so great a ‘reach’ as for scanning). Tracking of the mouse is at its most accurate with the arms in the 45-90-45 configuration [due to the values of sine-differences for 45 degrees (90 is divided by 2) in the trigonometry].

Right 70 clicking on the mouse icon in the Task Bar shows that the popped up menu also contains a ‘Scan’ command. If the ‘Scan’ command is selected, a sub-menu requests the user to ‘left 72 click’ on ‘light 91 on/off’ and then to select ‘Registration’.

Registration shows, on the display of the computer, a circular image of the area of the document where the digital camera 88 is currently focussed and with cross-hairs superimposed on that image. The mouse shell 56 is moved until the top left point of the rectangle to be scanned is shown and the left button 72 is clicked. Fine focussing is undertaken at this time. Then the mouse shell 56 is moved until the bottom right point of the rectangle to be scanned is shown and the left button 72 is clicked again. The host driver software ‘sizes’ that rectangle to fit the whole computer screen and switches the mouse shell 56 to scanning mode.

The user now moves the mouse shell 56 around the screen until all the image is captured. When the user believes capture is complete, the right button 70 is clicked and if any part of the image is incomplete it will flash (zoomimg can be used where screen resolution fails to show enough detail). The popped up menu will allow the missing scan to be completed or exit to the current application. Upon exit, the user is asked to name a file and folder for storing the image ( and its image format, e.g. ‘.jpeg’ or ‘.gif’)

The invention is further explained and described by the following claims.

1-50. (canceled)

51. A computer pointing apparatus comprising: support means; a first arm having a first end and a second end and being attached by said first end to said support means, said first end of said first arm being rotatable about said support means; a second arm, having a first end and a second end and being attached by said first end to said second end of said first arm, said first end of said second arm being rotatable about said second end of said first arm; first angle measuring means for measuring an angle between said first arm and said support means and for provide output indicative thereof; second angle measuring means for measuring an angle between said first arm and said second arm and for providing output indicative thereof; mouse means at a second end of said second arm; button means selectively operable on said mouse means for providing an output indicative of use of said mouse means; and communication means for conveying said output of said first angle measuring means, said output of said second angle measuring means, and said output of said button means to a computer.

52. An apparatus, according to claim 51, wherein said support means comprises first pulley means on, and static with reference to, a base unit, said first end of said first arm rotating co-axially with said first pulley means; second pulley means on said second end of said first arm, said second pulley means being free to rotate with respect to said second end of said first arm; first drive belt means, on said first pulley means and said second pulley means, operative to rotate said second pulley means with respect to said first arm in sympathy with the angle of said first arm to said base unit; third pulley means, co-axial with and fixed with reference to said second pulley means; fourth pulley means, at said second end of said second arm; and second drive belt means, on said third pulley means and said fourth pulley means, operative to turn said fourth pulley means in sympathy with the angle of said first arm to said base unit, said first angle measuring means being coupled to monitor the angle of said fourth pulley means.

53. An apparatus, according to claim 52, comprising fifth pulley means, on said second end of said first arm and static with reference to said second end of said first arm; sixth pulley means, on said second end of said second arm and free to rotate with respect to said second end of said second arm; and third drive belt means on said fifth pulley means and said sixth pulley mean, operative to rotate said sixth pulley means in sympathy with the angle of said first arm with respect to said second arm, said second angle measuring means being coupled to monitor the angle of said sixth pulley means.

54. An apparatus, according to claim 51, comprising logic processing means, operative to receive and convert said indications provided by said output of said angle measuring means to a position for said mouse means in an orthogonal axis coordinate system, and to communicate said position to the computer.

55. An apparatus, according to claim 52, comprising logic processing means, operative to receive and convert said indications provided by said output of said angle measuring means to a position for said mouse means in an orthogonal axis coordinate system, and to communicate said position to the computer.

56. An apparatus, according to claim 53, comprising logic processing means, operative to receive and convert said indications provided by said output of said angle measuring means to a position for said mouse means in an orthogonal axis coordinate system, and to communicate said position to the computer.

57. An apparatus, according to any one of the preceding claims, wherein said support means is operative to support said apparatus with said mouse means proximate to a surface of an object whose image is to be captured; said apparatus further comprising camera means, operative to move with said mouse means and operative to provide, as output, signals indicative of the image of the object.

58. An apparatus, according to claim 57, wherein said camera means comprises a selectably operable light source to illuminate the object whose image is to be captured.

59. An apparatus, according to claim 57, co-operative with the computer to scan a representation of an image of an object into the computer by noting the position of said camera means at each acquisition of an image slice, by assembling the image slices in the computer, and by indicating to a user those portions of the image to be acquired which have not yet been scanned.

60. An apparatus, according to claim 58, co-operative with the computer to scan a representation of an image of an object into the computer by noting the position of said camera means at each acquisition of an image slice, by assembling the image slices in the computer, and by indicating to a user those portions of the image to be acquired which have not yet been scanned

61. An apparatus, according to claim 51, wherein at least one of said first angle measuring means and said second angle measuring means comprises at least one of: a first pre recorded hard drive platter and a reading head for reading angular data therefrom; a nano-mechanical platter comprising a plurality of imprinted tracks, each imprinted track comprising a plurality of radially aligned angularly equispaced angular markers; and said apparatus comprising a reading head for reading said angular markers from said nano mechanical platter.

62. An apparatus, according to claim 61, wherein said hard drive platter comprises first, second and third radially aligned pre-recorded tracks, said pre recorded tracks each comprising a plurality of radially aligned markers, said apparatus employing Fleming's Right Hand Rule of magnetic induction to determine direction of rotation of said platter.

63. An apparatus, according to claim 52, wherein at least one of said first angle measuring means and said second angle measuring means comprises at least one of: a first pre recorded hard drive platter and and a reading head for reading angular data therefrom; a nano-mechanical platter comprising a plurality of imprinted tracks, each imprinted track comprising a plurality of radially aligned angularly equispaced angular markers; and said apparatus comprising a reading head for reading said angular markers from said nano mechanical platter.

64. An apparatus, according to claim 63, wherein said hard drive platter comprises first, second and third radially aligned pre-recorded tracks, said pre recorded tracks each comprising a plurality of radially aligned markers, said apparatus employing Fleming's Right Hand Rule of magnetic induction to determine direction of rotation of said platter.

65. An apparatus, according to claim 63, wherein at least one of said first angle measuring means and said second angle measuring means comprises at least one of: a first pre recorded hard drive platter and and a reading head for reading angular data therefrom; a nano-mechanical platter comprising a plurality of imprinted tracks, each imprinted track comprising a plurality of radially aligned angularly equispaced angular markers; and said apparatus comprising a reading head for reading said angular markers from said nano mechanical platter.

66. An apparatus, according to claim 64, wherein said hard drive platter comprises first, second and third radially aligned pre-recorded tracks, said pre recorded tracks each comprising a plurality of radially aligned markers, said apparatus employing Fleming's Right Hand Rule of magnetic induction to determine direction of rotation of said platter.

67. An apparatus, according to any one of claims 51, 63, 64, 65, and 66, wherein said support means is operative to support said apparatus with said mouse means proximate to a surface of an object whose image is to be captured; said apparatus further comprising camera means, operative to move with said mouse means and operative to provide, as output, signals indicative of the image of the object.

68. An apparatus, according to claim 67, wherein said camera means comprises a selectably operable light source to illuminate the object whose image is to be captured.

69. An apparatus, according to claim 67, co-operative with the computer to scan a representation of an image of an object into the computer by noting the position of said camera means at each acquisition of an image slice, by assembling the image slices in the computer, and by indicating to a user those portions of the image to be acquired which have not yet been scanned.

70. An apparatus, according to claim 68, co-operative with the computer to scan a representation of an image of an object into the computer by noting the position of said camera means at each acquisition of an image slice, by assembling the image slices in the computer, and by indicating to a user those portions of the image to be acquired which have not yet been scanned.

71. A computer pointing apparatus comprising: support means; a first arm having a first end and a second end and being attached by said first end to said support means, said first end of said first arm being rotatable about said support means; a second arm, having a first end and a second end and being attached by said first end to said second end of said first arm, said first end of said second arm being rotatable about said second end of said first arm; first angle measuring means for measuring an angle between said first arm and said support means and for provide output indicative thereof; second angle measuring means for measuring an angle between said first arm and said second arm and for providing output indicative thereof; mouse means at a second end of said second arm; button means selectively operable on said mouse means for providing an output indicative of use of said mouse means; third angle measuring means, for measuring an angle between said second end of said second arm and said mouse means, and communication means for conveying said output of said first angle measuring means, said output of said second angle measuring means, said output of said third angle measuring means and said output of said button means to a computer.

72. An apparatus, according to claim 71, wherein said support means comprises first pulley means on, and static with reference to, a base unit, said first end of said first arm rotating co-axially with said first pulley means; second pulley means on said second end of said first arm, said second pulley means being free to rotate with respect to said second end of said first arm; first drive belt means, on said first pulley means and said second pulley means, operative to rotate said second pulley means with respect to said first arm in sympathy with the angle of said first arm to said base unit; third pulley means, co-axial with and fixed with reference to said second pulley means; fourth pulley means, at said second end of said second arm; and second drive belt means, on said third pulley means and said fourth pulley means, operative to turn said fourth pulley means in sympathy with the angle of said first arm to said base unit, said first angle measuring means being coupled to monitor the angle of said fourth pulley means.

73. An apparatus, according to claim 72, comprising fifth pulley means, on said second end of said first arm and static with reference to said second end of said first arm; sixth pulley means, on said second end of said second arm and free to rotate with respect to said second end of said second arm; and third drive belt means on said fifth pulley means and said sixth pulley mean, operative to rotate said sixth pulley means in sympathy with the angle of said first arm with respect to said second arm, said second angle measuring means being coupled to monitor the angle of said sixth pulley means.

74. An apparatus, according to claim 71, comprising logic processing means, operative to receive and convert said indications provided by said output of said angle measuring means to a position for said mouse means in an orthogonal axis coordinate system, and to communicate said position to the computer.

75. An apparatus, according to claim 72, comprising logic processing means, operative to receive and convert said indications provided by said output of said angle measuring means to a position for said mouse means in an orthogonal axis coordinate system, and to communicate said position to the computer.

76. An apparatus, according to claim 73, comprising logic processing means, operative to receive and convert said indications provided by said output of said angle measuring means to a position for said mouse means in an orthogonal axis coordinate system, and to communicate said position to the computer.

77. An apparatus, according to any one of claims 71 to 76, wherein said support means is operative to support said apparatus with said mouse means proximate to a surface of an object whose image is to be captured; said apparatus further comprising camera means, operative to move with said mouse means and operative to provide, as output, signals indicative of the image of the object.

78. An apparatus, according to claim 77, wherein said camera means comprises a selectably operable light source to illuminate the object whose image is to be captured.

79. An apparatus, according to claim 77, co-operative with the computer to scan a representation of an image of an object into the computer by noting the position of said camera means at each acquisition of an image slice, by assembling the image slices in the computer, and by indicating to a user those portions of the image to be acquired which have not yet been scanned.

80. An apparatus, according to claim 78, co-operative with the computer to scan a representation of an image of an object into the computer by noting the position of said camera means at each acquisition of an image slice, by assembling the image slices in the computer, and by indicating to a user those portions of the image to be acquired which have not yet been scanned

81. An apparatus, according to claim 71, wherein at least one of said first angle measuring means, said second angle measuring means and said third angle measuring means comprises at least one of: a first pre recorded hard drive platter and and a reading head for reading angular data therefrom; and a nano-mechanical platter comprising a plurality of imprinted tracks, each imprinted track comprising a plurality of radially aligned angularly equispaced angular markers; and said apparatus comprising a reading head for reading said angular markers from said nano mechanical platter.

82. An apparatus, according to claim 81, wherein said hard drive platter comprises first, second and third radially aligned pre-recorded tracks, said pre recorded tracks each comprising a plurality of radially aligned markers, said apparatus employing. Fleming's Right Hand Rule of magnetic induction to determine direction of rotation of said platter.

83. An apparatus, according to claim 81 or 82, wherein said support means is operative to support said apparatus with said mouse means proximate to a surface of an object whose image is to be captured; said apparatus further comprising camera means, operative to move with said mouse means and operative to provide, as output, signals indicative of the image of the object.

84. An apparatus, according to claim 83, wherein said camera means comprises a selectably operable light source to illuminate the object whose image is to be captured.

85. An apparatus, according to claim 83, co-operative with the computer to scan a representation of an image of an object into the computer by noting the position of said camera means at each acquisition of an image slice, by assembling the image slices in the computer, and by indicating to a user those portions of the image to be acquired which have not yet been scanned.

86. An apparatus, according to claim 84, co-operative with the computer to scan a representation of an image of an object into the computer by noting the position of said camera means at each acquisition of an image slice, by assembling the image slices in the computer, and by indicating to a user those portions of the image to be acquired which have not yet been scanned.

87. An apparatus, according to claim 51, wherein at least one of said first angle measuring means and said second angle measuring means is coupled to receive drive from a respective gear chain for magnifying the angular movement.

88. An apparatus according to claim 86, wherein each respective gear chain drive is coupled to turn a respective CD-ROM disk burned with a pattern to be read to record angular movement.

89. An apparatus, according to claim 71, wherein at least one of said first angle measuring means, said second angle measuring means and said third angle measuring means is coupled to receive drive from a respective gear chain for magnifying the angular movement.

90. An apparatus according to claim 88, wherein each respective gear chain drive is coupled to turn a respective CD-ROM disk burned with a pattern to be read to record angular movement.

91. An apparatus, according to claim 54, wherein said logic processor means is further operative to perform at least one of: receiving output from said image processing means and providing the image to the computer; providing operational commands to said image processor means; and receiving commands from the computer.

92. An apparatus, according to claim 74, wherein said logic processor means is further operative to perform at least one of: receiving output from said image processing means and providing the image to the computer; providing operational commands to said image processor means; and receiving commands from the computer.
